(19) United States
(12) Patent Application Publication
(10) Pub. No.: US 2005/0022152 A1
(43) Pub. Date: Jan. 27, 2005

(54) White body modeing and virtual evaluation system for mechanical assemblies

(76) Inventors: Daniel J. Turk, Dublin, OH (US); Kenji Akuzawa, Kawachi-gun (JP)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 10/616,140

(22) Filed: Jul. 9, 2003

(51) Int. Cl. G06F 9/44

(52) U.S. Cl. 717/100

(57) ABSTRACT

A system providing an interactive virtual model or “white body” builder (“WBB”) interconnected with different groups involved in an enterprise centric activity related to the design, simulation, and evaluation of mechanical components. Mesh, assembly and evaluation data of predetermined components, after a virtual assembly or test and evaluation, becomes available for design input and refinement to all participating members associated in a task group through a network in which a continually updated master database is maintained.

### BACKGROUND OF THE INVENTION

This invention relates to white body modeling for virtual event evaluation of mechanical assemblies and parts, for example, as used in motor vehicle crash testing.

The physical modeling of vehicle crash events is conventionally a process that requires considerable time and personnel involving different skill sets and data aggregations. In a typical physical crash test time line, several engineering staff members, over an extended period of several weeks or more, design and assemble a physical structure for a physical test, after which a forensic analysis of the structure is conducted. In the virtual analogue of physical testing, a virtual white body is created, a testing protocol compiles a parts list, the parts are virtually meshed, assembled and welded, a virtual crash event is carried out, and the compiled data evaluated.

Mesh models for simulating complex parts are known. Examples of patents involving mesh techniques include U.S. Pat. No. 6,445,390 to Aftosmis, et al.; U.S. Pat. No. 6,429,867 to Deering, U.S. Pat. No. 6,317,704 to Furuhata et al.; U.S. Pat. No. 6,259,453 to Itoh et al., and U.S. Pat. No. 6,124,857 to Itoh, et al. Likewise, methods and apparatus for distributing and managing design information in a production facility and selecting a graphical object and changing display attributes thereof are also known. U.S. Pat. No. 6,212,441 to Hazama et al. and U.S. Pat. No. 6,337,700 to Kinoe et al. relate to design tools.

There is a need in the scheme of virtual testing for a mesh and parts management system that integrates design, and simulation testing and evaluation, whereby design refinement in view of feedback from a crash event evaluation can be achieved in a network environment. In the present invention, the disparate aspects of the motor vehicle development process, namely design, assembly, testing, redesign, re-assembly, and re-testing are integrated in a system in which all aspects and personnel are interrelated, thereby reducing the time and complexity of crash event testing.

### BRIEF SUMMARY OF THE INVENTION

Objects of the invention are to develop a virtual white body model integrating design and assembly information from pre-existing, disparate sources otherwise involved in the vehicle design process and to reduce the time required to achieve a crash event evaluation.

In the invention simulation engineers will not be required to gather and compile a white body parts list. The former manual assembly and welding of mesh parts will be automated. An automatic meshing option (batch mesh) is provided. Existing CAD software is used in the design process and the system described herein allows wizard guided assembly of motor vehicle and/or vehicle part or assembly models into a white body crash model that enables the integration of crash event feedback and white body changes through the design and testing process.

The system includes tags for connection locations and implements an auto meshing option. The required mesh size is adjustable for a predetermined or desired accuracy. The system is expandable beyond white body parts to chassis, interior, and other assemblies and allows increased responsiveness to weekly, or other periodic, design changes. The white body builder prepares finite element mesh models of a white body for use in full-vehicle simulations, such as crash events.

In its operation, the invention comprises an integrated system in which, initially, a data library is linked to a digital prototype station and a parts list is extracted. The user is then prompted to identify the parts desired to evaluate in a simulation and to mark the parts. The marked parts are processed through a mesh process, and the information is saved in a database. Individual parts selected are then connected or assembled in a design or compilation instructed by the user. Finally, the separate mesh model parts are built into a computer simulation format and exported.

Building the computer simulation includes associating material properties to the mesh parts to distinguish between different materials. The number of mesh elements necessary to simulate a part may range from 100 to 100,000. The mesh is an approximation of the actual physical part having specific one, two, or three dimensional geometrical shapes, for example, lines, triangles, squares, cubes, boxes, tetrahedrons, prisms, and the like.

The further objects of the invention are to improve the method of generating virtual full vehicle models and large subassembly computer simulation models and to expand the use of full vehicle computer simulations, beyond crash testing to computer simulations involving durability and fatigue prediction, white body modal analysis, hybrid vehicle modeling with transfer path analysis, suspension analysis and steering response and feedback, and other simulations where white bodies or subassemblies are required. Current methods, using a crash white body, do not provide an adequate base model for other simulations.

The invention is described more fully in the following description of the preferred embodiment considered in view of the drawings in which:

### DESCRIPTION OF THE SEVERAL VIEWS OF THE DRAWINGS

FIG. 1 shows the interrelationship in an organization of a network of various design, assembly, and testing data and sources with respect to the white body model builder system.

FIG. 2 shows the interactive access, input and feedback aspects of data input and output interrelationships in the network for various design, assembly, and testing data and personnel sources with respect to the white body model builder system.

FIG. 3 shows various input and output data criteria with respect to the white body virtual model builder, as data from various sources is assembled to generate a virtual model for evaluation.

FIG. 4 shows an example of the use of the virtual model for testing where a data file is accessed, an evaluation is conducted, and feedback from the evaluation is returned to be used as input into the model builder.

FIG. 5 shows steps in an example of white body builder system operation.

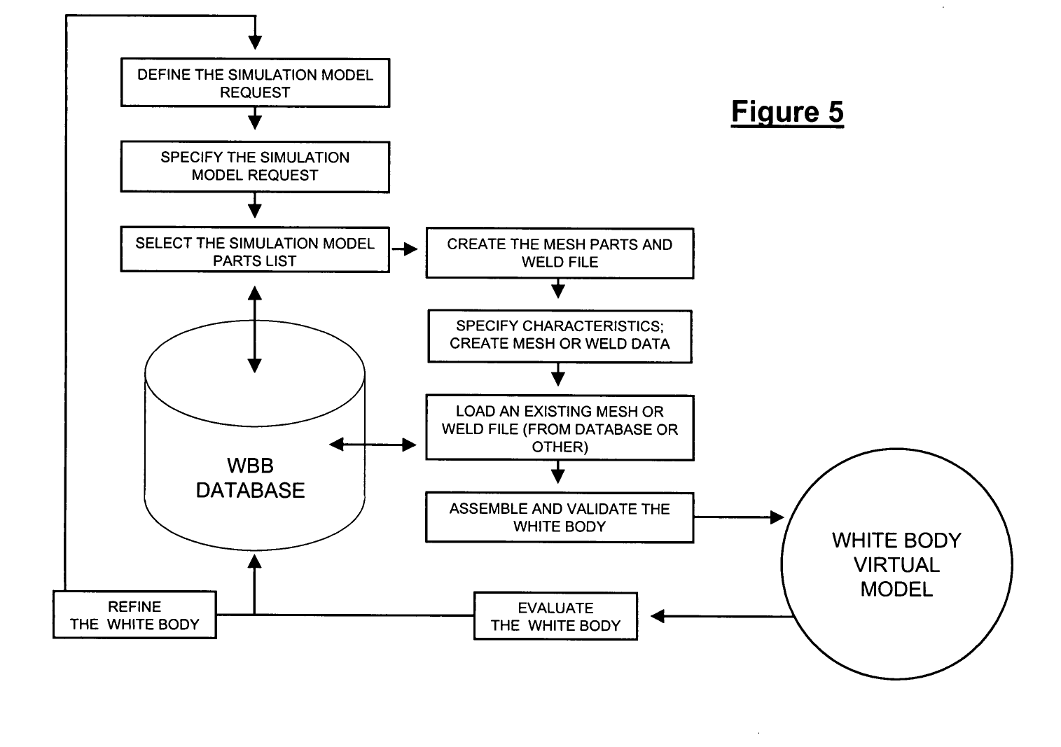

### DETAILED DESCRIPTION OF THE INVENTION

In brief, the white body builder (WBB) of the invention provides a convenient interface within the overall design process that 1) defines a simulation model request, 2) specifies the simulation details, 3) selects the simulation model parts list, 4) creates the mesh parts and weld file specifying characteristics, 5) creates mesh and weld data, 6) loads existing mesh and weld files (from a WBB database or other), and 7) assembles and validates the white body.

The invention guides the simulation engineer through the simulation model building process, listing the specified and handling all communications between the CAD design database and the users involved in the design, event evaluation and feedback and refinement process. Integrating the simulation model parts list and the associated mesh specifications, the invention is the launch point for activities related to simulation model creation, testing and refinement.

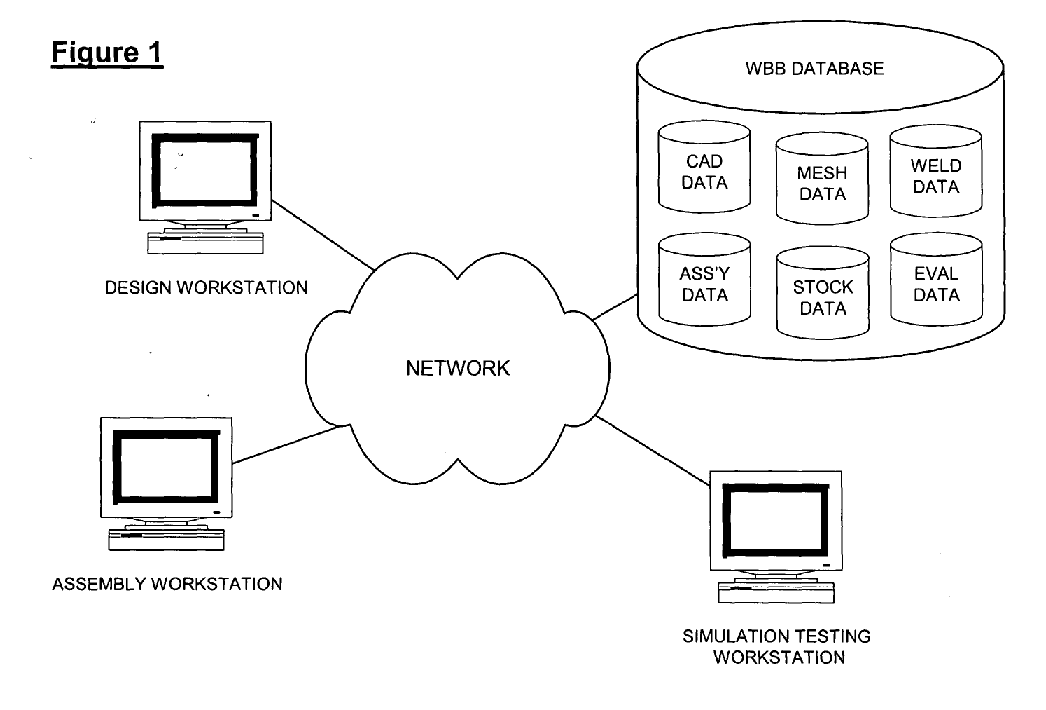

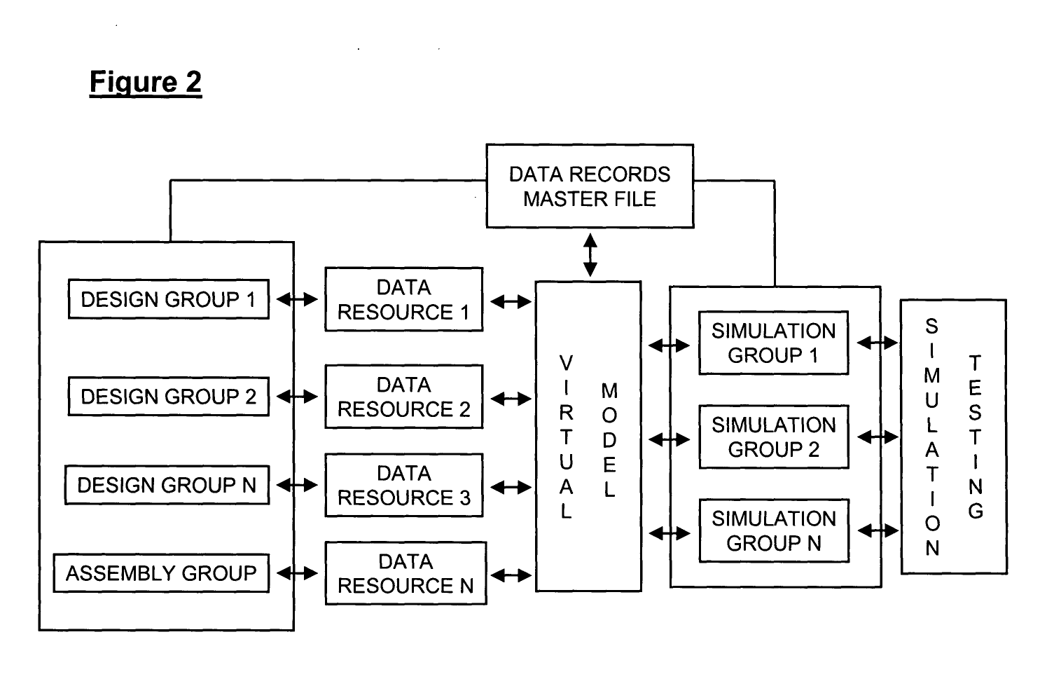

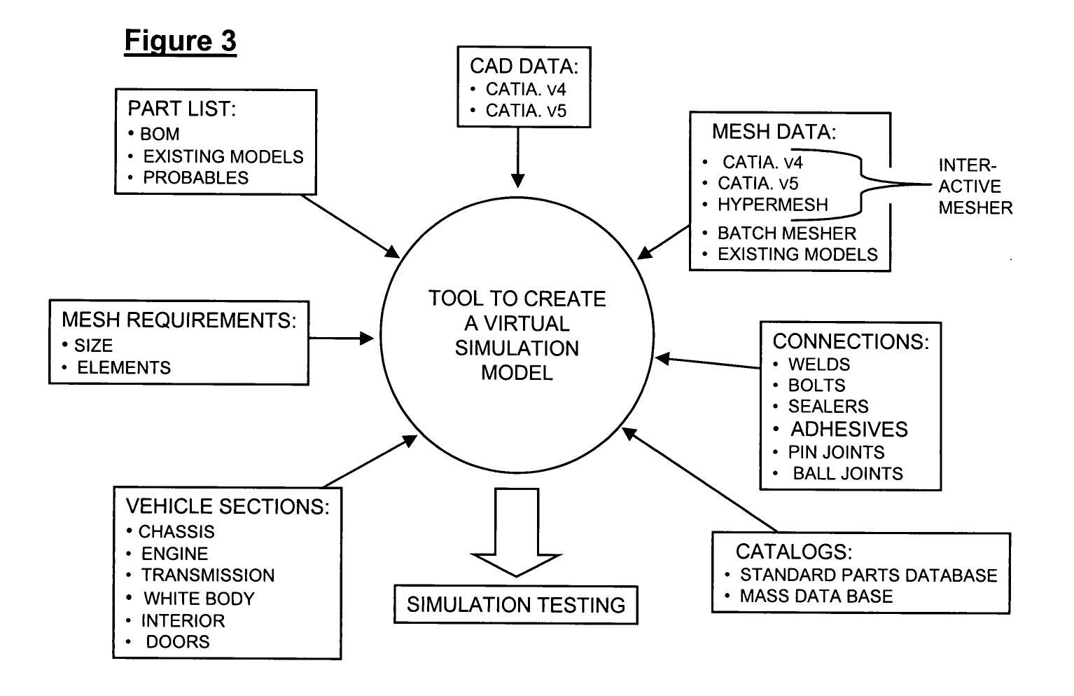

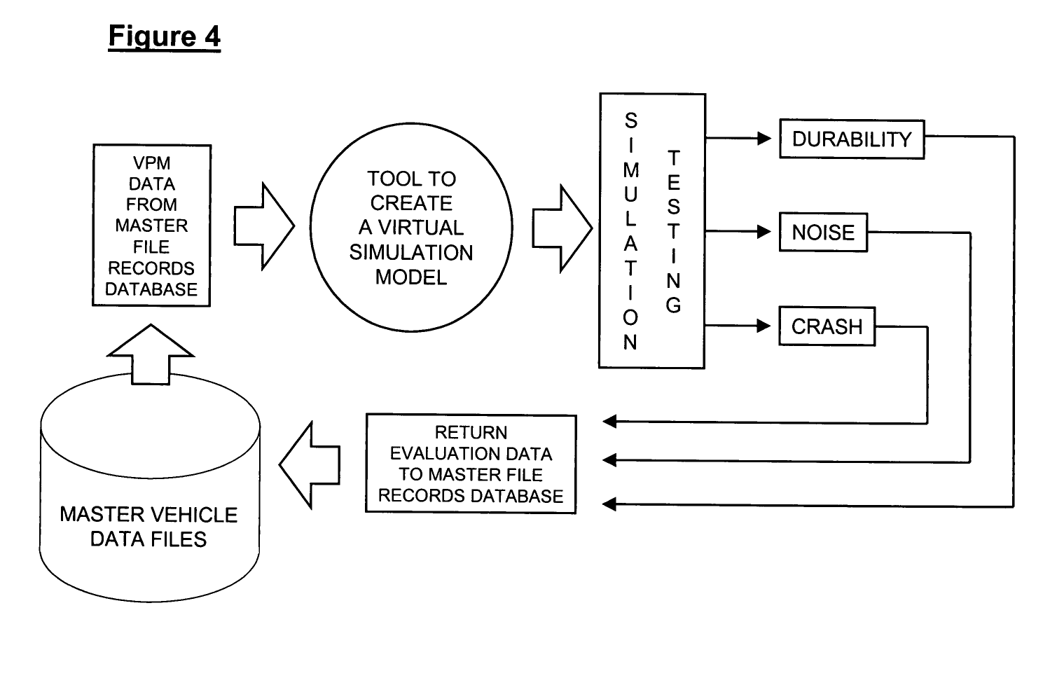

In the general overview shown in FIG. 1, the system provides an interactive virtual model builder or “White Body Builder” (“WBB”) interconnected in a network with different groups involved in an organization centric activity related to the design, simulation, and evaluation of mechanical components. Evaluation data of predetermined components, after a virtual test or assembly and evaluation, becomes available for design input and refinement, essentially through the same database from which the model was generated. In an example as shown in FIG. 2, the interactive input and output data relationships involved in part data creation, assembly, simulation, testing and evaluation (feedback) is shown among the various groups involved in an enterprise design effort. FIG. 3 shows parts and/or their related property data imported from a CAD station or parts inventory database. Parts for an assembly are selected and assigned properties corresponding to the existing, predetermined shape, material, or configuration of the part. The assembly to be evaluated is built according to assembly characteristics such as welds, fasteners such as bolts or rivets, and the like, and the assembly is broken down into finite elements used in virtual testing, and the part or assembly file so generated is saved as a virtual surrogate of the physical analogue, namely as a white body (“WB”) data record for output for simulation and evaluation by various groups as shown in FIG. 4.

The master file of data records may be accessible to multiple groups having different responsibilities in the overall design process, and to multiple users involved in the design of various parts. Using a search protocol, the mesh part database may be searched, for example, for the same part type of different models allowing design changes to be built and updated. In an instance where a design, evaluated in an assembly may not be perfect, for example, where parts protrude in an assembly where a smooth surface is required, changes to the connections and the connecting parts may be made. The assembly is correspondingly updated. Left and right mirror images of parts (e.g., left and right taillights or rear view mirrors, doors) may be similarly virtually assembled. An update task list is maintained to monitor evaluations that determine incongruities or failures and the design refinements required accordingly. Hence on a basis of mesh, assembly and weld (conjoin), parts and assemblies are refined in an actively updated interactive database commonly accessible from essentially the beginning to the end of the design process, through the point at which a part, module or assembly is refined such that the part or assembly may be approved for production use as a common part for different models, or as a singular part for a unique application or model.

Depending on a part configuration, predetermined data values are assigned to 1) geometric shapes such as an engine block, a rod or panel, 2) to mass corresponding to metal, plastic, foam and other material densities, and/or 3) to assembly characteristics such as a weld, a fastener, or an adhesive bond; and the characteristics are interrelated. For example, in a durability evaluation, parts are selected, assembled, assigned an appropriate mesh and evaluated under time and load specifications. For noise, adhesives and door seals that connect and protect from external and internal sources are likewise meshed in finite increments of mass and size and characteristics, assembled and evaluated. In a similar manner, a virtual prototype model of an entire vehicle may be assembled from a bill of materials and a parts list assembled from existing and proven parts and models, and/or from specially created bill of materials and parts list for a new design or model.

For structural analysis, CAD data, mesh data, weld data, and assembly data are input and a virtual WB structure is output. For noise, crash and durability simulations, additional data relating to joints such as seals, engine mounts, suspension points, and bolts is input. Vehicle simulation modules are generated by adding parts such as the transmission, seats, engine, door locks, wiper motor, and the like. Simulation tests are then set up through interfaces with the assembly data coordinating with testing parameters such as an impact barrier and a physical property definition such as an initial velocity. Thus, the system provides a means for assembling a virtual prototype model (“VPM”).

The VPM modeling system integrates design and assembly information from the pre-existing disparate sources involved in an enterprise centric design and integrates, in a network system a data library maintaining data files corresponding to a parts list. The network links data files to a work stations of the members of the various groups within the network enterprise involved in the design of a VPM corresponding to a mechanical assembly.

The respective work stations of the enterprise participants allow the participants to select an assembly for evaluation and assemble the associated data files representing the physical properties of the parts comprising the assembly from one or more than one parts data lists maintained in a database library. In doing so, one or more data file from the library associated with one or more part that is to be conjoined in an assembly with one or more other parts in the data file are also identified. The parts and their data files are associated in the assembly and processed through a mesh procedure, such that imperfections in the mesh are identified and fixed. The mesh data is saved in a database in the library and the assembly is built by associating mesh data with bond data relating to the manner in which conjoined parts are bonded in the assembly. The built assembly is translated into a computer simulation format data record which is thereby maintained as a computer simulation format data record for use in simulation testing. The computer simulation format data record typically includes an association of material properties to the meshed parts to distinguish between different materials. The number of mesh elements recorded to simulate a part is optionally determined according to parameters such as size, criticality, and complexity, but will typically range from approximately 100 to approximately 100,000 or more points. As so included in the master database, the computer simulation format data record may be accessed for evaluation with respect to one or more than one of crash impact, durability and noise, and after such an evaluation, the data record for the assembly may be modified after an evaluation event, taking into consideration, appropriate feedback concerning the assembly, as a result of the event. Thus, a data file of a part or assembly is essentially maintained in a continuous loop with respect to design, testing and refinement in which the part or assembly modifications made in any of the stages of the process are integrally preserved and accessible at each stage in a continuing testing and improvement cycle. Significant improvements in time savings and design coordination are achieved by the network system of the invention compared to prior systems in which each disparate group maintained separate data files and protocols identified uniquely with a group and its role in the design process. In the present system, the separateness of different functions is dissolved; and data generated at the various design stages is integrated and maintained in a master database promptly accessible to all, resulting in better coordination and accuracy in the design and testing of parts and assemblies.

### EXAMPLE I

The following is an overview of the program when employed in the sequence of crash modeling: 1) gather vehicle structure information and three dimensional part representations for the VPM, 2) create three dimensional representations identifying joint and bond locations between separate contacting parts, 3) assemble and weld the white body, 4) check each assembly for any part and weld problem 5) utilize VPM capabilities to compare simulated vehicle structure with post-simulation design changes, and 5) provide a design change update method for the white body virtual model.

For other modeling, alternative mesh parts are stored in a master database for the custom needs, allowing the reuse of existing mesh data to quickly build alternative white bodies. The benefit of the system is that a white body VPM model can be generated in approximately two weeks or less. Simulation engineers will not have to gather and compile a white body part list. Manual assembly and welding of virtual mesh parts is automated and automatic meshing (batch mesh) is allowed as an option.

### EXAMPLE II

In the following Example, the system of the invention is referred to as the “WBB Assistant.” Following the prompts of the WBB Assistant, a user constructs a virtual model following the sequence set out below beginning with a) describing a simulation model and b) then assembling and validating the model.

A) The User First Describes the Simulation Model:

1) The first task is to describe the simulation model by selecting a development code, purpose and solver. The user will also enter description information and initiate the process by clicking the Create button.
2) Get Simulation Part List: The WBB Assistant will query the VPM database for the available sections and zones. It will process this data and fill the drop boxes. The user will pick sections, zones, part numbers or all to specify the desired structural parts list for the simulation model.
3) Select Simulation Parts: The WBB Assistant displays the retrieved part list. To perform an action, activate a part radio button and click on the add, remove or propagate button. To select a part to be included in the simulation model, check the box in front of the part number.
4) Add Simulation Parts: If a part is added, this screen is used to supply the necessary information.
5) Specify Mesh Characteristics: To set the mesh characteristics, set the active part with the radio button and click Mesh Specs. This is only necessary if the default values are not acceptable. For example, the CATIA material. This screen is used to modify the default mesh specifications or choose a non-standard mesh type. Size, type, material and thickness get their default values from Parts List.
6) Create Mesh File: To create a mesh, set the active part with the radio button and click Launch HM or Launch CATIA. This will open an HM or CATIA sessions with the selected model loaded. Proceed to create a mesh and then click Attach HM or Attach CATIA to save the mesh into the database. While working meshing, the HM or CATIA file can be saved to a local disk or to the DFS data storage.
7) Find Mesh File: To attach an existing mesh file, set the active part with the radio button and click Find Mesh File. This can be used to load in any type of mesh file created with any application at any time.
8) Select Mesh File: Click the Browse button to search for an outside mesh file and then click Select Mesh File. Or set your search criteria and click the Query Meshes button to search for a mesh from a previous simulation model already in WBB. If Query is selected, the WBB Assistant will list all of the mesh files that match your criteria. Set the radio button in front of the mesh file to use and click the Select Mesh File button.
9) Attach Mesh File: If necessary, modify the settings and click the Attach Mesh File button to store the mesh file.
10) Specify Weld Characteristics: To set the weld characteristics, set the active part with the radio button and click Weld Specs. This is only necessary if the default values are not acceptable. This screen is used to modify the default weld specifications. The default values are based on the type of simulation chosen.
11) Create Weld File: To create a weld file, set the active part with the radio button and click Create Weld File. This will launch a background CATIA script to generate the Weld File. To edit the existing weld file, set the active part with the radio button and click Edit Weld File. This will launch a text editor with the current weld file loaded.
12) Find Weld File: To attach an existing weld file, set the active part with the radio button and click Find Weld File.
13) Select Weld File: Click the Browse button to search for an outside weld file and then click Select Weld File. Or set your search criteria and click the Query Welds button to search for a weld file from a previous simulation model already in WBB. If Query is selected, the WBB Assistant will list all of the weld files that match your criteria. Set the radio button in front of the weld file to use and click the Select Weld File button.
14) Attach Weld File: If necessary, modify the settings and click the Attach Weld File button to store the Weld file.
   B) The Simulation Model is Assembled and Validated:
   15) Build: Set the active comp with the radio button and click Build to assemble and weld the active comp and all sub-comps below.
16) Assemble/Validate: Select comp and click Check Comp to load in HM. Perform visual checks and zero time step runs. Correct any problems with the assembly. Click Save Comp to save any changes. Caution: data saved this way will be over-written the next time the Build button is selected for this comp. Click Update Parts to save the changes back to the mesh parts and weld file.
17) Attach Comp: Click Attach Comp to save HM comp file in place of individual mesh parts. Future Building comments will ignore part meshes and use HM comp instead.
18) Valid changes in HM: Since the Update Parts function has to break the assembly back into its base pieces, there are some limitations on the level of modification. Allowable changes include: i) Shape =>same mesh file; and ii) Thickness, Material=>prompt to change mesh type. Invalid changes include adding, removing, renaming component collectors and welds.

Thus, the system of the invention provides an interactive virtual model white body builder interconnected with different groups involved in an enterprise centric activity related to the design, simulation, and evaluation of mechanical components. Mesh, assembly and evaluation data of predetermined components, after a virtual assembly, test or evaluation, becomes available for design input and refinement to all participating members associated in a task group through a network in which a continually updated master database is maintained. Parts for an assembly are selected from the master database or a database of existing parts, and assigned properties corresponding to the predetermined shape, material, or configuration of the part. The assembly to be evaluated is built according to assembly characteristics such as welds, fasteners such as bolts or rivets, and the like, and the assembly is broken down into finite elements used in virtual testing. The white body assembly file so generated is saved as a virtual surrogate of the physical part in the master database for retrieval for refinement, testing and evaluation by various enterprise groups, whose improvements (feedback) to the assembly are, in turn, associated with the assembly in the master database in a continual updating process ultimately resulting in a tested and refined part or assembly approved for commercial release.

Having described the invention in detail, those skilled in the art will appreciate that, given the present disclosure, modifications may be made to the invention without departing from the spirit of the inventive concept herein described. Therefore, it is not intended that the scope of the invention be limited to the specific and preferred embodiments illustrations as described. Rather, it is intended that the scope of the invention be determined by the appended claims.

1. A virtual white body modeling system integrating design and assembly information from pre-existing disparate sources involved in an enterprise centric design process for a mechanical assembly comprising:
an integrated system including a data library maintaining data files corresponding to a parts list;
a network linking the data files to a work station of one or more than one member of the various groups within the enterprise involved in the design of a mechanical assembly;
means in the work station for 1) selecting a part and the associated data file representing the physical properties of the part from one or more than one parts data lists maintained in the library; 2) extracting one or more data file from the library associated with one or more part that is to be conjoined in an assembly with one or more other parts in the data file; 3) associating the parts and their data files in an assembly; 4) processing the selected parts through a mesh process; 5) saving the assembly mesh data in a database in the library; 6) building the assembly by associating mesh data with bond data relating to the manner in which conjoined parts are bonded in the assembly; and 7) translating the built assembly into a computer simulation format data record.

2. The system of claim 1 including the further steps of conducting a computer simulation with respect to the assembly, refining the assembly in view of the simulation and updating the data associated with the assembly in the parts data list maintained in the library.

3. The system of claim 1 in which the computer simulation format data record includes an association of material properties to the meshed parts to distinguish between different materials.

4. The system of claim 1 in which the number of mesh elements recorded to simulate a part ranges from approximately 100 to approximately 100,000 or more.

5. The system of claim 2 in which the computer simulation format data record is accessed for evaluation with respect to one or more than one of crash impact, durability and noise.

6. The system of claim 4 in which the data record for the assembly is modified after an evaluation.
